(19) United States
(12) Patent Application Publication
(10) Pub. No.: US 2026/0369434 A1
(43) Pub. Date: Nov. 19, 2026

(54) Enhanced Energy Generation in Nuclear Reactors Using Neutron-Boron Reactions as a Supplementary Reaction Pathway

(71) Applicant: Mikhail Y Inyushin, Bayamon, PR (US)

(72) Inventor: Mikhail Y Inyushin, Bayamon, PR (US)

(21) Appl. No.: 19/209,486

(22) Filed: May 15, 2025

(51) Int. Cl. G21C 3/40; G21C 1/30; G21C 5/12; G21C 15/28; G21C 19/31

(52) U.S. Cl. CPC G21C 3/40; G21C 1/30; G21C 5/12; G21C 15/28; G21C 19/31

(57) ABSTRACT

A method and apparatus for generating energy using neutron-induced boron-10 reactions. The system harvests alpha and Li-7 particles and gamma radiation for combined electric and thermal energy production. This approach offers a reduced-cost, reduced-waste alternative or supplement to traditional uranium-based nuclear reactors.

### FIELD OF THE INVENTION

The present invention relates to the field of nuclear energy production. Specifically, it describes systems and methods for increasing energy efficiency and reducing cost in nuclear reactors by utilizing the neutron-boron (¹⁰B+n) reaction as a supplementary means of energy conversion, in combination with conventional self-sustained fission reactions.

### BACKGROUND OF THE INVENTION

Conventional nuclear reactors primarily rely on fissile materials such as uranium-235 or plutonium-239 to sustain a chain reaction. While effective, these fuels are costly, generate long-lived radioactive waste, and require complex control systems to maintain criticality.

The neutron capture reaction of boron-10 (¹⁰B+n→⁷Li+α+γ) offers an alternative or supplementary mechanism for energy production. This reaction yields both high-energy alpha particles (≈52% or 1.47 MeV), lithium recoil (≈30% or 0.84 MeV), and gamma radiation (≈17% or 0.48 MeV), which can be harvested for direct electric generation or thermal conversion. Boron-10 is significantly less expensive than enriched uranium and presents a lower radiological hazard. In some embodiments, a natural boron with about 19.9% of the initial boron-10 isotope can be used without enrichment. Energy generation from the neutron-boron reaction can be used either as an addition to existing reactors or as a newly built combination with conventional reactors or non-critical nuclear amplifiers.

### SUMMARY OF THE INVENTION

The invention provides a nuclear-energy system in which boron-10 is deliberately placed within the neutron flux of a reactor—whether the reactor is critical, near-critical, or deliberately sub-critical—to absorb neutrons by the ¹⁰B(n,α)⁷Li reaction and thereby release additional energy. The boron-containing material may reside in a coolant, a blanket, a structural component, or a replaceable insert, and may be supplied as a solid, liquid, dissolved species, or suspended particulates. Because boron-10 is far less expensive and more widely available than enriched fissile fuel, the reaction augments the reactor's thermal output without a proportional increase in fissile inventory.
In baseline embodiments the reaction energy is harvested in the same manner as conventional reactor heat: the boron-enriched region transfers its sensible and latent heat to a coolant loop that drives a steam or gas turbine and electrical generator. The boron augmentation can therefore be added to existing reactor architectures with minimal redesign.
In alternative embodiments at least a fraction of the kinetic energy carried by the alpha particles and lithium-7 recoil ions generated in the boron capture event is converted directly to direct-current electrical power. This is accomplished by disposing an electrostatic or electromagnetic collector—such as opposed electrodes immersed in the boron-enriched liquid metal (which can also be a coolant)—so that ionisation currents are captured at a potential difference of 0.01-10 volts. Direct conversion operates in parallel with, or independently of, the conventional thermal cycle and can improve overall electric-conversion efficiency.
The invention thus encompasses: (i) reactors in which boron-10 neutron capture supplements or replaces fissile-heat generation; (ii) methods of operating such reactors by introducing boron-10 material into an existing neutron flux; and (iii) optional direct-charge collection assemblies for converting a portion of the boron-reaction energy directly to electricity.

### This Allows:

1. Substitute and reduce the amount of rare fissile materials to generate energy in nuclear reactors.
2. Supplement existing fission reactors by embedding boron-10 enriched materials to get additional heat for thermal conversion to electrical energy.
3. Enable hybrid systems for direct-electric and thermal energy harvesting using particle separation.

### Energy Comparison:

1. One kilogram of uranium-235 undergoing complete fission yields approximately 82 terajoules (TJ) of energy. In reality, complete fission of uranium never happens. In a standard fissile uranium nuclear reactor cycle, approximately 3% of the uranium-235 is consumed, leading to the need for fuel replacement. The remaining uranium can be reused after costly reprocessing of the spent fuel and removal of radioactive waste.
2. One kilogram of boron-10 undergoing complete neutron capture yields approximately 22.3 TJ of energy. No radioactive waste is produced, and the reaction can utilize a much bigger percentage of boron-10.

Although uranium has a higher energy density, boron also gives large amounts of energy, but is significantly cheaper, safer, and easier to handle. Boron is not as rare as other fissile materials; boron concentrations in soil are typically around 30 mg/kg. In addition, it can be used in inherently subcritical systems, removing the need for complex safety controls.

### On Radioactive Waste:

Fission of light elements such as boron-10 does not result in the production of heavy, long-lived radioactive isotopes. The primary products—helium nuclei (alpha particles) and lithium-7—are stable or have minimal radiological concern. This contrasts with uranium or plutonium fission, which produces a wide spectrum of radioactive fission products that require extensive long-term storage.

### Description of Direct Particle-Energy Harvesting in Liquid Metal

Conventional nuclear facilities convert fission heat to electricity by generating steam that drives gas or steam turbines. The overall efficiency of such thermodynamic cycles is fundamentally limited by the Carnot condition. By contrast, the present disclosure provides a method for direct conversion of charged-particle kinetic energy released in the \hat{ }10B(n, α)\hat{ }7Li reaction into electric power, thereby exceeding the Carnot ceiling that constrains purely thermal systems. When a thermal neutron is captured by the \hat{ }10B nucleus (thermal-capture cross-section ≈3 837 barns), the reaction proceeds as:

\hat{ }10B+n→α(1.47 MeV)+\hat{ }7Li(0.84 MeV)+γ(0.48 MeV)(ΣE≈2.31 MeV).

Approximately 52% of that energy resides in the doubly-charged α-particle and about 30% in the singly-charged \hat{ }7Li recoil. By allowing these particles to stop in a moderately conducting liquid metal, their kinetic energy creates dense tracks of electron-ion pairs. If the medium sustains the charges long enough for an external field to separate them, a substantial fraction of the reaction energy can be extracted as direct current.

Selection of the liquid-metal converter: To perform this function, the liquid metal should:
Exhibit low stopping power so that α-particles and Li recoils emerge from the boron source region and traverse several micrometres of metal.
Possess intermediate electrical conductivity—high enough for charge transport, yet low enough that ions and electrons do not recombine instantaneously.
Remain chemically and mechanically stable over reactor temperatures and under intense neutron/gamma flux.
Be chemically compatible with boron additives and with inert-electrode materials.

Gallium meets these criteria particularly well. Pure Ga melts at 29.8 °C (with known super-cooling behaviour) and remains liquid beyond 2 000 °C in vacuum. Its thermal-neutron capture cross-section is only ~2.75 barns; activation products are short-lived and do not impose significant radiological burden. Bulk electrical conductivity is ≈3.7×10\hat{ }4 S m⁻¹ (EGaIn≈3.4×10\hat{ }6 Sm⁻¹), values that allow simultaneous presence of free electrons and Ga⁺ ions for micro- to millisecond time scales.

### Boron Carrier Phase

Boron may be dispersed as sub-micron particles of B_4C or as gallium borate (GaBO₃). The carrier must satisfy two constraints:

Range compatibility—In B_4C, a 1.47 MeV α travels ~2-5 μm (Li⁺: ~1 μm). Particles ≤1 μm ensure that most charged fragments escape into the surrounding Ga where they ionize the continuum.

Density and separability—GaBO₃ (ρ≈3.3 g cm⁻³) is closer in density to Ga (6.1 g cm⁻³) than B_4C (2.52 g cm⁻³), promoting uniform suspension and facilitating chemical cycling when natural-boron (~20% \hat{ }10B) is used.

### Charge Yield

Stopping the reaction fragments in gallium produces approximately:

| Particle | Energy (MeV) | e⁻-ion pairs | Charge (fC) |
|---|---|---|---|
| α | 1.47 | ~5.9 × 10⁴ | ~9.4 |
| \hat{ }7Li | 0.84 | ~3.4 × 10⁴ | ~5.4 |
| Total | 2.31 | ~9.2 × 10⁴ | ~14.8 |

### Electrode System

An electrostatic field of order 1-2 V mm⁻¹ is imposed between chemically inert electrodes immersed in the gallium layer. A preferred pair comprises:
Anode: zirconium (work function φ≈4.05 eV; corrosion-resistant in Ga).
Cathode: iridium (φ≈5.27 eV; excellent high-temperature stability).

The difference in work functions (~1.22 V) minimises parasitic emission and aids charge separation. Inter-electrode spacing of 3-10 mm balances space-charge recombination versus voltage drop; ~5 mm is practical in most geometries. High-surface-area textures (e.g., sintered foams or finned plates) further enhance collection current.

### Expected Conversion Performance

Up to 50% of thermal neutrons incident on the converter can be captured for optimized boron loading and neutron moderation. With an estimated 60% efficiency in collecting the ionisation charge, ~35% of the charged-particle energy is converted directly to electricity. The residual 65%, together with the 0.48 MeV γ component and any unconverted neutron energy, appears as heat that can be removed by the gallium coolant and fed to a secondary Rankine or Brayton cycle. Overall plant efficiency exceeding 45% is thereby achievable, surpassing the purely thermal baseline. 5-10 cm of lead (or tungsten) around the converter layer attenuates the 0.48 MeV γ-ray flux to regulatory dose levels while contributing additional recoverable heat.

Accordingly, the disclosed gallium-boron liquid-metal converter enables a hybrid reactor architecture in which a single working fluid both (i) directly harvests charged-particle energy and (ii) removes residual thermal power, enhancing total electrical output and reducing balance-of-plant complexity.

### DETAILED DESCRIPTION

The reaction can be exploited in two principal ways:

### 1. Thermal-Only Energy Recovery (Retrofit Option)

Exchangeable boron modules. In existing plants, \hat{ }10B must be incorporated so that it can be inserted, inspected, and removed without major outage—for example, as peripheral boron-bearing rods or cartridge-type assemblies.
Supplementary γ-absorbers. High-Z inserts (e.g., Pb- or W-loaded sleeves) are positioned adjacent to the boron modules to capture the 0.48 MeV γ-rays and convert their energy to heat. The kinetic energy of the α-particles and \hat{ }7Li recoils is likewise deposited as heat within the solid matrix.
Requalification analyses. Before implementation, the core must undergo coupled neutronics—thermal-hydraulics—corrosion-product-deposition recalculation to confirm criticality margins, temperature profiles, coolant chemistry, and activity transport.
Balance-of-plant upgrades. Because the boron reaction adds a new heat source, the cooling circuits, heat exchangers, and turbine train may require uprating or parallel loops to accommodate the extra thermal power.
A similar approach must be performed to design a new plant that implements the neutron-boron reaction for energy harvesting.

### 2. Combined Direct-Electric and Thermal Energy Harvesting Configuration

Neutron source. The system is driven by an external or self-sustaining neutron field—e.g., a fusor, spallation target with sub-critical amplifier, or a conventional critical core.

Liquid-metal converter. \hat{ }10B-enriched material is dispersed in a gallium-based melt that either (i) doubles as the primary coolant or (ii) circulates through dedicated converter channels situated within, or around, the core. The boron phase is supplied as sub-micron B₄C particles or gallium borate (GaBO₃) powder so that the α-particles and \hat{ }7Li recoils can exit the boron matrix and ionise the liquid metal.

Charge-collection electrodes. Opposed electrodes (e.g., zirconium anode/iridium cathode) are immersed 2-5 mm apart. A field of approximately 1-10 V mm⁻¹ sweeps Ga⁺ ions to the anode and electrons to the cathode, limiting recombination. For a reaction rate of 1019 captures s⁻¹, a 3 V bias supports ~1.48×10⁵ A, yielding ≈440 kW of direct electrical power.

Thermal complement. The 0.48 MeV γ-ray as well as any unrecovered charged-particle energy are absorbed by surrounding high-Z cladding (e.g., Pb or W) and removed as sensible heat for a secondary Rankine or Brayton cycle.

### Lithium and Spent-Boron Management

A calm, gravity-settling zone is incorporated at the top of the liquid-metal loop. Low-density reaction products—boron-11, Li-7 compounds, and their oxides—float upward and are skimmed into a foam-filtration trap for periodic removal. The collected material may be re-enriched in \hat{ }10B and returned to service. The Ga-based melt circulates in a sealed loop with scheduled purification to maintain electrical and chemical purity.

### Hybrid Power-Conversion Architecture

A high-capacity DC bus and protective power-electronics stage maintain the electrode bias, regulate load, and manage fault currents of order 10¹⁰ A.

Heat recovered from γ-absorption and charge-recombination drives conventional steam or gas turbines, enabling dual-mode output—simultaneous direct current and thermal power.

### Advantages

Lower cost per joule relative to uranium or plutonium fuels.
Minimal long-lived waste—primary activation products are short-lived and readily separable.
Hybrid design flexibility, permitting independent optimisation of electrical and thermal outputs.

In both configurations, providing ready physical access to the boron inventory—whether rod-type for thermal-only systems or suspended/dispersed in a liquid-metal converter for hybrid systems—simplifies monitoring, replacement, and end-of-life management while ensuring that future recalculations or operational adjustments can be implemented with minimal downtime.

### BRIEF DESCRIPTION OF THE DRAWINGS

FIG. 1: Hybrid reactor schematic layout showing the neutron source (1), boron-10 reaction chamber (2), direct energy harvesting electrodes (3), and thermal loop (4).

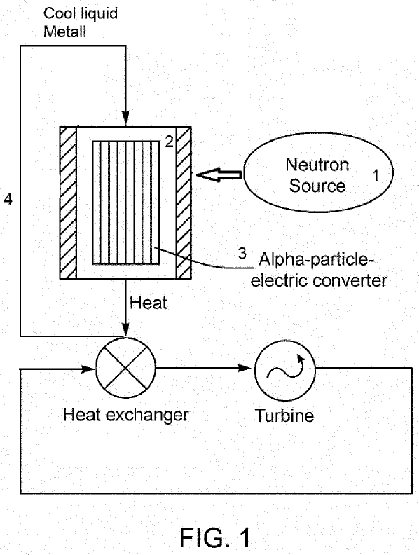

FIG. 2: Electrode system illustrating charge collection from a gallium medium containing suspended B₄C microspheres.

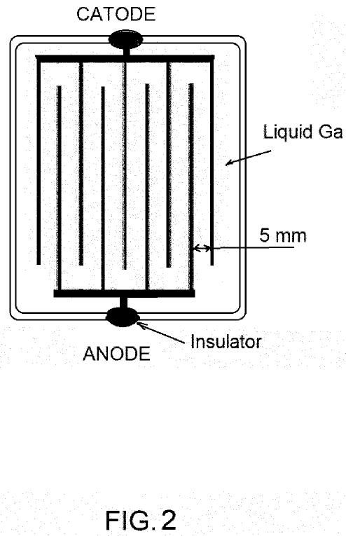

FIG. 3: Coolant circulation system using gallium-based liquid metal with boron additives as the primary cooling and energy harvesting medium.

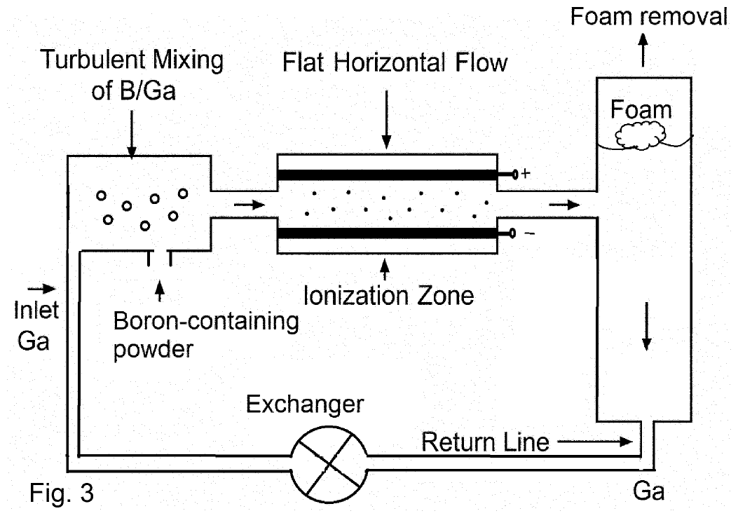

### COMPARISON WITH PRIOR ART

The neutron-boron reaction—specifically the interaction of boron-10 with thermal neutrons to produce alpha particles and lithium-7—is currently utilized in Boron Neutron Capture Therapy (BNCT), a form of targeted radiation therapy for cancer. There are many patents related to BNCT, but they are not related to the generation of electric energy. For example, U.S. Pat. No. 10,603,516B2 describes a neutron source for BNCT. Others use the neutron-boron reaction for neutron detection, using boron-10 as neutron-sensitive material. For example, U.S. Pat. No. 8,835,864B2 uses boron-10 to detect neutrons because the generated alpha particles ionize the nearby semiconductor plate. However, the neutron-boron reaction is not currently employed for large-scale energy generation. In nuclear power plants, boron is primarily used as a neutron absorber to control the fission process, not as a fuel source. The energy released from the neutron-boron reaction in BNCT is localized and intended for therapeutic purposes, and the infrastructure required for energy harvesting from such reactions on a scale suitable for power generation does not exist at this time.

In existing applications for nuclear energy production, boron-10 is added to the fuel just to stabilize the neutron flux. For example, the existing patent CN101281797A focuses on the incorporation of boron-containing compounds within nuclear fuel rods to act as burnable absorber (poison). Specifically, it describes fuel rods comprising sintered mixtures of actinide compounds (such as uranium dioxide) and boron-containing compounds (like B₄C or BN). These boron compounds are uniformly distributed within the fuel pellets to manage reactivity over the fuel cycle-if the fuel starts to produce fewer neutrons because it is burned, boron-10 reduces neutron capture as well, maintaining the neutron flux stable. In contrast, our invention pertains to energy generation in nuclear reactors using neutron-boron reactions. Our approach involves integrating boron-10 enriched materials within a reactor system to capture neutrons, resulting in the release of alpha particles and gamma rays. These emissions are then harnessed through a hybrid system combining alpha-electric harvesting and gamma-thermal conversion to produce electricity and heat.

Key distinctions include:

### 1. Application Purpose:

CN101281797A: Enhancement of fuel performance and reactivity control in nuclear reactors.
Our Invention: Energy generation through direct harvesting of particles resulting from neutron-boron reactions.

### 2. Energy Harvesting Approach:

CN101281797A: Does not involve direct energy harvesting from boron reactions; the focus is on reactivity control.
Our Invention: Employs a hybrid system to harvest energy directly from the products of neutron-boron reactions.

These differences highlight the novelty and unique application of our invention in the field of energy generation, distinguishing it from the fuel performance-focused technology described in CN101281797A.

1. An energy-generating nuclear reactor comprising:
(a) a core that contains fissile fuel and produces a sustained neutron flux; and
(b) a boron-containing neutron-capture region positioned so that neutrons from the fissile fuel are absorbed by boron-10, thereby releasing reaction energy that increases the total power output of the reactor.

2. The reactor of claim 1, wherein at least a portion of the kinetic energy of charged particles produced by the boron-10 neutron-capture reaction is converted directly to electrical power by an electrostatic or electromagnetic collector disposed proximate to the boron-containing region.

3. A method of augmenting the power of a nuclear reactor, comprising:
(a) introducing boron-10-enriched material into a neutron flux produced by an operating or sub-critical reactor or by an external neutron source;
(b) allowing neutrons to be captured by the boron-10, thereby generating additional heat and charged particles; and
(c) converting the additional heat to electricity by conventional thermal means and, optionally, converting at least part of the charged-particle energy directly to electricity.

4. The reactor of claim 1, wherein the boron is present as a solid, liquid, dissolved, or particulate additive in the reactor coolant or structural elements.

5. The reactor of claim 1, wherein the boron-10 enrichment is greater than 20 atomic percent.

6. The reactor of claim 1, wherein the boron-containing neutron-capture region is configured so that an effective multiplication factor k<sub>eff</sub> of the core remains below 1.0.

7. The reactor of claim 2, wherein the collector comprises opposed electrodes separated by a gap filled with a liquid-metal coolant.

8. The reactor of claim 2, wherein a plurality of direct-charge collectors are electrically connected in series to obtain an output voltage of at least ten volts.

9. The reactor of claim 1, wherein the boron-containing region is replaceable or regenerable to permit continued operation after depletion of boron-10.

10. The method of claim 3, wherein step (a) comprises circulating a liquid metal or molten-salt coolant that carries suspended boron-10-bearing particles.

11. The method of claim 3, wherein the reactor is maintained sub-critical and at least part of the neutron flux is supplied by an accelerator-driven or fusion-based external neutron source.

12. The method of claim 3, wherein step (c) further comprises separating reaction products from the boron-containing medium and recycling the boron for renewed neutron capture.
